(19) United States
(12) Patent Application Publication
(10) Pub. No.: US 2008/0145270 A1
(43) Pub. Date: Jun. 19, 2008

(54) ADDITIVE TO MITIGATE HYDROGEN SULFIDE AND METHOD OF USING THE SAME

(76) Inventors: Dingyi Ye, Grand Forks, ND (US); Daniel J. Stepan, Grand Forks, ND (US)

Correspondence Address: JOHNSON & ASSOCIATES, PO BOX 90698, AUSTIN, TX, 78709-0698, US

(21) Appl. No.: 11/957,252

(22) Filed: Dec. 14, 2007

Related U.S. Application Data
(60) Provisional application No. 60/870,037, filed on Dec. 14, 2006.

(51) Int. Cl. A61D 9/00; A01P 1/00; A01N 59/16; A01N 59/00

(52) U.S. Cl. 422/5; 424/616; 424/646; 424/655; 424/647

(57) ABSTRACT

A method and apparatus is provided for reducing H₂S in high-strength by-products by preventing H₂S formation rather than temporarily scavenging H₂S after it has formed. One exemplary additive uses an SRB inhibitor alone or in combination with a scavenging agent.

### CROSS REFERENCE TO RELATED APPLICATIONS

This application claims priority under 35 U.S.C. § 119/120 to co-pending, commonly owned U.S. provisional patent application Ser. No. 60/870,037, attorney docket number EER.P0031P, filed on Dec. 14, 2006, entitled “AN ADDITIVE TO MITIGATE HYDROGEN SULFIDE AND METHOD OF USING THE SAME,” (pending) which is incorporated by reference herein.

### STATEMENT REGARDING FEDERALLY SPONSORED RESEARCH OR DEVELOPMENT

This invention was made with government support under Contract Number 2004-38846-02153 awarded by the United States Department of Agriculture-Cooperative State Research, Education, and Extension Service. The government has certain rights in the invention.

### FIELD OF THE INVENTION

This invention is aimed at controlling hydrogen sulfide (H₂S) and reducing odors formed during the treatment of various high-strength by-products. These high-strength by-products include, but are not limited to, turkey, swine, and cattle manure, wastewater, and biosolids. The invention controls H₂S and the associated odor through the addition of a sulfide control additive to the by-product stream. The additive is comprised of a sulfate reducing bacteria (SRB) inhibitor and a scavenging agent. The additive, when used properly, is a selective inhibitor of the SRB, and has no side effect on all other bacteria in the high-strength by-products.

### BACKGROUND OF THE INVENTION

Hydrogen sulfide is a toxic, colorless gas with a characteristic odor of rotten eggs. It is considered a broad-spectrum poison, meaning it can poison several different systems in the body, in particular, the nervous system. Hydrogen sulfide is also notable for its capability to cause corrosion. It is corrosive to metals, and it is also a precursor to sulfuric acid formation, which corrodes concrete, metals, and other materials. Hydrogen sulfide is a major source of odor in wastewater treatment systems and other high-strength by-product treatment systems. In addition, H₂S may corrode various materials used in sewer and treatment plant construction, resulting in costly damage to equipment and facility. Efficient sulfide control is important in order to reduce future corrosion and damage to existing sanitary sewer systems, treatment facilities, etc.

This invention is aimed at determining the most cost-effective sulfide scavenger when compared to three commercial products in experimental tests. The resulting invention is a new technology to control sulfide in high-strength by-products. The new technology, compared against the results obtained by the commercial products, shows that this invention is much more effective and will cost significantly less than other sulfide control additives in the market.

Current technologies to control H₂S include, but are not limited to, chemical scavenging techniques, oxidation, alkalinity/pH adjustment, physical covers, fume (H₂S vapor) scrubbing, and promotion of microbial denitrification processes. These are explained as follows:
1. Chemical Scavenging Techniques: Scavenging refers to the removal of H₂S from the wastewater after it has formed and before it volatizes to the atmosphere. Typical scavenging materials include either organic or inorganic chemical compounds.
2. Oxidation: The use of chemical oxidants such as oxygen, hydrogen peroxide, ozone, potassium permanganate, and chlorine, etc., to convert sulfide to sulfate (SO₄)²⁻ ion.
3. Alkalinity/pH Adjustment: Adding alkalinity to adjust the pH of the high-strength by-products to high levels effectively inhibits all biological activity and, subsequently, sulfate-respiring bacteria.
4. Physical Covers: In the case of wastewater ponds or lagoons, the placement of a cover on the surface of the wastewater can reduce the release of H₂S to the atmosphere, allowing the H₂S to form, but not allowing the gas to escape into the atmosphere.
5. Fume Scrubbing: Treatment of H₂S-containing emissions from treatment systems can be accomplished by physical, chemical, and/or biological scrubbing methods.
6. Promotion of Microbial Denitrification Processes: The addition of nitrate and nitrite to i) promote biological oxidation of H₂S conducted by some denitrifying bacteria (photosynthetic and autochemotrophic denitrifying bacteria), and/or ii) create conditions less favorable to the growth of and inhibit sulfate-reducing bacteria.

These existing commercially available technologies are less effective in that they are unable to selectively inhibit the SRB and prevent continuous production of H₂S. One difference between this invention and others is that current technologies (except promotion of the denitrification process and pH adjustment) merely attempt to control the H₂S after it is produced. In contrast, the present invention reduces H₂S production in addition to mitigating the pre-existing H₂S. Despite the fact that promotion of the denitrification process also mitigates the production of H₂S, denitrification only temporarily suppresses SRB, and nitrogen-containing chemicals have to be continuously added. Compared to the currently available commercial technologies, the present invention is more effective and less costly to implement.

Prior literature discusses the use of Group VI oxyanions, including molybdate, permanganate, selenate, tungstate, and vanadate, as a selective inhibitor of SRB; however, some articles conclude that at least molybdate is not a selective SRB inhibitor. Existing literature suggests that the addition of molybdate into a high-strength by-product stream inhibits not only the SRB, but also other microorganisms such as beneficial methane producing bacteria. This invention shows, however, that the addition of a proper quantity of a Group VI oxyanion-containing additive is in fact a selective inhibitor of SRB without impacting other beneficial microorganisms.

### SUMMARY OF THE INVENTION

Herein disclosed is a method of reducing H₂S in high-strength by-products and a method of enhancing methane production through the treatment of high-strength by-products. This invention is unique in that it selectively inhibits the formation of H₂S through the use of a sulfide control additive, comprised of an SRB inhibitor(s) or an SRB inhibitor(s) and a scavenging agent(s). This selective inhibition of the SRB and the reduction of pre-existing H₂S by means of a sulfide controlling additive effectively reduce H₂S produced by high-strength by-products in anaerobic conditions.

In some embodiments, the method further encompasses applying an additive to the high-strength by-product, at least a portion of the additive is a scavenging agent and with the remainder of the additive being an SRB inhibitor. In some embodiments, the proportion of scavenging agent to SRB inhibitor is dependent upon factors including the concentration of pre-existing sulfide and the population of existing SRB in the high-strength by-product.

Other features and advantages of the present invention will be apparent from the accompanying drawings and from the detailed description that follows below.

### BRIEF DESCRIPTION OF THE DRAWINGS

The present invention is illustrated by way of example and not limitation in the figures of the accompanying drawings, in which like references indicate similar elements and in which:

FIG. 1 is a graph illustrating the results of an inhibitor use on treating wastewater.

### DETAILED DESCRIPTION

Herein disclosed is a method of reducing H₂S in high-strength by-products that is a significant improvement over existing H₂S control technologies as it prevents H₂S formation rather than temporarily scavenging H₂S after it has formed. The disclosed method and combination of additive inputs enables cost savings for both the reduction of H₂S odors and the replacement of H₂S damaged systems.

Hydrogen sulfide in high-strength by-products is produced by SRB. The high-strength by-products may contain varying concentrations of liquid from a semi-solid, including, but not limited to, turkey, swine, and cattle manure, which can be up to 60% liquid, to a liquid, including, but not limited to, wastewater, which can be up to 100% liquid. One of the embodiments of the present invention uses an additive, including a scavenging agent and an SRB inhibitor, to scavenge pre-existing H₂S in the high-strength by-product and to inhibit the creation of additional H₂S by the SRB. Once the SRB are killed, production of H₂S is eliminated.

The additive is comprised of an SRB inhibitor alone or a combination of a scavenging agent and an SRB inhibitor. The SRB inhibitors include Group VI oxyanions. These SRB inhibitors are used to deplete Adenosine-triphosphate (ATP) pools in the SRB, thereby resulting in the death of the SRB. This invention demonstrates a novel use of a Group VI oxyanion to control the conversion of SO₄²⁻ to toxic H₂S formed during treatment of high-strength by-products. One embodiment will include molybdate as the SRB inhibitor. In one example, the concentration of the SRB inhibitor is no more than 15 mM, preferably no more than 10 mM, to inhibit the SRB and yet have little to no impact the methane producing bacteria (MPB). The concentration of the SRB inhibitor can be higher in other examples. Once the SRB are no longer viable, the sulfate remains in solution. When the SRB are inhibited, the CO₂ that would have otherwise been produced will be diverted to the MPB for the production of methane (CH₄) by methanogens. Similarly, the hydrogen which would have otherwise been used by SRB will be taken by the methanogens. The hydrogen will combine with the CO₂ to form CH₄. The inhibition of SRB by the preferred concentration of the SRB inhibitor results in the enhancement of CH₄ production. In addition, a scavenging agent(s) may be included. The scavenging agent is either organic or inorganic. The scavenging agents include, but are not limited to, triazines, as organic compounds, or ferric chloride, ferrous chloride, hydrogen peroxide, and potassium permanganate as inorganic compounds. The scavenging agent is added to scavenge pre-existing H₂S.

The application of the additive is dependant on multiple factors. The ideal concentration of the additives depends on multiple factors including 1) the strength of the by-product, 2) the concentration of sulfur-containing compounds in the by-product, 3) the operation temperature of the treatment system, and 4) the concentration of sulfate in the by-product. In one embodiment, the SRB inhibitor in the additive will have a concentration no higher than 15 mM, preferably no higher than 10 mM.

The benefits of the present invention are: 1) more effective treatment of high-strength by-products containing sulfide; 2) minimize H₂S produced in the high-strength by-product using a Group VI oxyanion containing additive; and 3) eliminate sulfide odor produced by SRB during treatment of high-strength by-products.

The additive of the present invention can be used in any desired manner, as one skilled in the art would understand. The additive can be added to the wastewater/by-products after they are produced to control H₂S. The concentrated additive can be diluted and then directly added to the wastewater/by-products; no specific mixing is required.

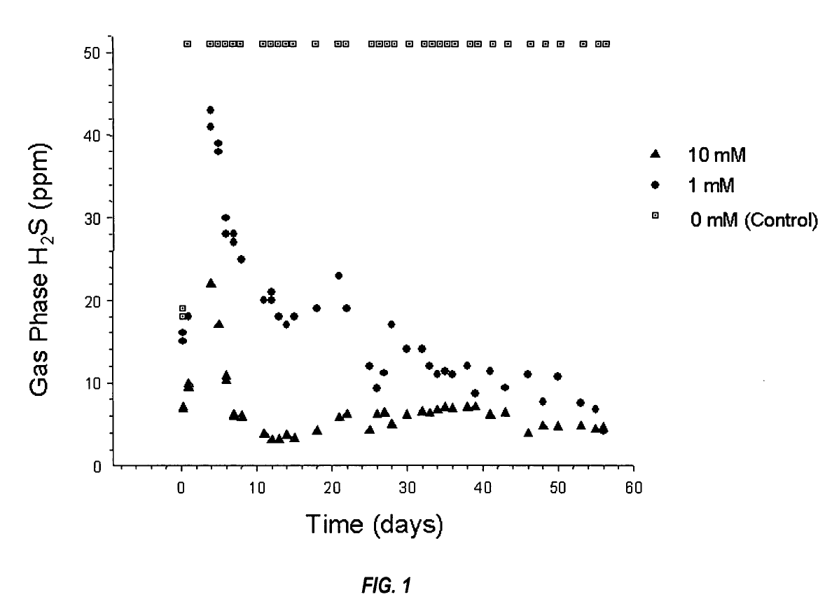

FIG. 1 is a graph illustrating the results of an inhibitor use on treating wastewater. FIG. 1 shows the concentration of gas-phase H₂S as a function of time, for different concentrations (10 mM, 1 mM, and 0 mM (a control)). As shown, the concentration of gas-phase H₂S over a 60-day period was significantly reduced by the inhibitor. The combination of inhibitor with a scavenger has the synergistic effect that at the beginning of the treatment already existing sulfide will no longer be available for the SRB such that the inhibitor will have a more immediate effect. H₂S production is thereby quicker suppressed when using a combination of scavenger and inhibitor than when using the inhibitor without the scavenger.

In the preceding detailed description, the invention is described with reference to specific exemplary embodiments thereof. Various modifications and changes may be made thereto without departing from the broader spirit and scope of the invention as set forth in the claims. The specification and drawings are, accordingly, to be regarded in an illustrative rather than a restrictive sense.

What is claimed is:

1. A method, wherein an additive is used in anoxic/anaerobic treatment of high-strength by-products to control the creation of H₂S and the associated odor.

2. The method of claim 1, wherein the high-strength by-products include, but are not limited to, by-products of varying degrees of moisture including, but not limited to, turkey, swine, or cattle manure, biosolids, and/or wastewater.

3. The method of claim 1, wherein the additive is a comprised of a sulfate-reducing bacteria (SRB) inhibitor.

4. The method of claim 3, wherein the sulfate-reducing bacteria inhibitor comprises any one or combination of the Group VI oxyanions, including molybdate, permanganate, selenate, tungstate, and vanadate.

5. The method of claim 3, wherein the addition of the SRB inhibitor into the high-strength by-product increases methane production.

6. The method of claim 5, wherein the SRB inhibitor in the additive has a concentration less than or equal to 15 mM.

7. The method of claim 5, wherein the SRB inhibitor in the additive has a concentration less than 10 mM.

8. The method of claim 5, wherein the SRB inhibitor in the additive has a concentration low enough so as to not significantly adversely affect methane producing bacteria.

9. The method of claim 1, wherein the additive is comprised of a combination of a sulfate-reducing bacteria (SRB) inhibitor and one or more scavenging agents.

10. The method of claim 9, wherein the scavenging agent is comprised of any one or combination of these organic or inorganic constituents, including, but not limited to, triazines, ferric chloride, ferrous chloride, hydrogen peroxide, and potassium permanganate.

11. The method of claim 1, wherein the additive is a combination of a sulfate-reducing bacteria inhibitor(s) and a scavenging agent(s) depending on the specific composition of the by-product and the surrounding circumstances.

12. An additive used in anoxic/anaerobic treatment of high-strength by-products for controlling the creation of H₂S and the associated odor comprising:
a sulfate-reducing bacteria (SRB) inhibitor.

13. The additive of claim 12, wherein the sulfate-reducing bacteria inhibitor comprises one or more Group VI oxyanions.

14. The additive of claim 12, wherein the SRB inhibitor has a concentration less than or equal to 15 mM.

15. The additive of claim 12, wherein the SRB inhibitor has a concentration low enough so as to not adversely affect methane producing bacteria.

16. The additive of claim 1, further comprising one or more scavenging agents.

17. The additive of claim 16, wherein the scavenging agent is comprised of one or more of: triazines, ferric chloride, ferrous chloride, hydrogen peroxide, and potassium permanganate.
